(19) United States
(12) Patent Application Publication
(10) Pub. No.: US 2024/0367809 A1
(43) Pub. Date: Nov. 7, 2024

(54) INLET AND OUTLET AIR GEOMETRY AND COMPONENTS TO REDUCE NOISE FROM AN AIRCRAFT COMPONENT ENCLOSURE

(71) Applicant: VerdeGo Aero, Inc., Daytona Beach, FL (US)

(72) Inventors: David N. Spitzer, Port Orange, FL (US); Eric Richard Bartsch, Wilmette, IL (US); Jared Schmal, Lexington, KY (US); Austin Cassels, Daytona Beach, FL (US); Richard Pat Anderson, De Leon Springs, FL (US)

(21) Appl. No.: 18/580,953

(22) PCT Filed: Nov. 17, 2022
(86) PCT No.: PCT/US22/50273

§ 371 Date: Jan. 19, 2024

Related U.S. Application Data
(60) Provisional application No. 63/280,598, filed on Nov. 17, 2021.

(51) Int. Cl. B64D 33/02

(52) U.S. Cl. CPC B64D 33/02; B64D 33/06; B64D 2033/0206

(57) ABSTRACT

An enclosure for an aircraft powerplant includes an air inlet, an air outlet, and at least one sidewall forming the enclosure and fluidly connecting the air inlet and the air outlet. The enclosure further includes a cavity configured to house at least one component of the aircraft powerplant. The cavity is within the enclosure and formed by the at least one sidewall. The enclosure further includes a noise reduction chamber comprising a plurality of channels configured to permit air to pass through the noise reduction chamber.

### CROSS-REFERENCE TO RELATED PATENT APPLICATION

This application is a 371 National Stage application of International PCT Application No. PCT/US2022/050273, filed Nov. 17, 2022, which claims the benefit of U.S. Provisional Patent Application No. 63/280,598, filed Nov. 17, 2021, the entire contents of each of which are hereby incorporated by reference in their entirety.

### BACKGROUND

Various types of aircraft may be used to transport goods or people. Locations where it may be desirable to move goods or people may be populated, such as in urban areas. It therefore may be desirable to reduce noise emitted from aircraft that is used near people. Similarly, if an aircraft is piloted by a human on board or otherwise is capable of transporting humans, it may also be desirable to reduce noise emitted from the aircraft based on noise regulations and/or to make travelling in that aircraft more pleasant for a passenger and/or crew of the aircraft.

### SUMMARY

In an embodiment, an enclosure for an aircraft powerplant includes an air inlet, an air outlet, and at least one sidewall forming the enclosure and fluidly connecting the air inlet and the air outlet. The enclosure further includes a cavity configured to house at least one component of the aircraft powerplant. The cavity is within the enclosure and formed by the at least one sidewall. The enclosure further includes a noise reduction chamber comprising a plurality of channels configured to permit air to pass through the noise reduction chamber.

In an embodiment, an enclosure includes an air inlet, an air outlet, and at least one sidewall forming the enclosure and fluidly connecting the air inlet and the air outlet. The at least one sidewall forms a chamber. The enclosure further includes a plurality of inner walls in the chamber that form a plurality of channels configured to permit air to pass through the chamber. The plurality of inner walls are parallel to one another.

In an embodiment, an apparatus includes an engine and an enclosure. The engine is inside the enclosure, and the enclosure further includes an air inlet, an air outlet, and at least one sidewall forming the enclosure and fluidly connecting the air inlet and the air outlet. The at least one sidewall forms a chamber. The enclosure further includes a plurality of inner walls in the chamber that form a plurality of channels configured to permit air to pass through the chamber. Exhaust air from the engine passes through the plurality of channels.

### BRIEF DESCRIPTION OF THE DRAWINGS

FIG. 1 illustrates a side cross-sectional view of an enclosure having noise reduction components in accordance with an illustrative embodiment.

FIG. 2A is a front perspective view showing an air inlet of an example enclosure having noise reduction components therein in accordance with an illustrative embodiment.

FIG. 2B is a side view showing the example enclosure of FIG. 2A in accordance with an illustrative embodiment.

FIG. 2C is a rear view showing the example enclosure of FIG. 2A in accordance with an illustrative embodiment.

FIG. 2D is a top view showing the example enclosure of FIG. 2A in accordance with an illustrative embodiment.

FIG. 3 is a rear perspective view showing an air outlet of the enclosure of FIG. 2A in accordance with an illustrative embodiment.

FIG. 4 is a top perspective view of noise reducing channels in the noise reducing chamber of the enclosure of FIG. 2A in accordance with an illustrative embodiment.

FIG. 5 is a top perspective view of another example enclosure having noise reduction components therein in accordance with an illustrative embodiment.

FIG. 6 is a side view of the enclosure of FIG. 5 in accordance with an illustrative embodiment.

FIG. 7 is a front view of the enclosure of FIG. 5 in accordance with an illustrative embodiment.

FIG. 8 is a perspective view of the enclosure of FIG. 5, showing the enclosure as being partially transparent in accordance with an illustrative embodiment.

FIG. 9 is a perspective view of another example enclosure, showing the enclosure as being partially transparent and having noise reduction components therein in accordance with an illustrative embodiment.

FIG. 10 is a top view of the enclosure of FIG. 9 in accordance with an illustrative embodiment.

FIG. 11 is a side view of the enclosure of FIG. 9 in accordance with an illustrative embodiment.

FIG. 12 is a rear view of the enclosure of FIG. 9 in accordance with an illustrative embodiment.

FIG. 13 is a rear view of the enclosure of FIG. 9, except showing the enclosure as opaque in accordance with an illustrative embodiment.

### DETAILED DESCRIPTION

Described herein are various embodiments for reducing noise emitted by an aircraft component such as an aircraft powerplant or component thereof. Although several embodiments described herein relate to enclosures for aircraft powerplants, such as engine cowlings, the various embodiments described herein may be used for components of aircraft other than powerplants and engines, and further still may be used to reduce noise emitted from components other than those of aircraft (e.g., helicopters, airplanes, vertical takeoff and landing (VTOL) aircraft, short takeoff and landing aircraft (STOL), etc.). For example, the embodiments described herein may also be implemented for any source of noise through which or around which air may pass, such as components of boats, motorcycles, automobiles, any other motor vehicle, or even for stationary components that generate noise around which or through which air passes.

Inlet and outlet airflow of noise producing components such as aircraft powerplants can be sources of noise, as the airflow into or out of those components can act as a medium through which noise and vibration can propagate. For example, in an aircraft having a hybrid powerplant, that hybrid powerplant may include a piston, rotary, or turbine engine that emits noise and has inlet and outlet airflow through which that noise may travel. Described herein are various embodiments for designing the geometry of the inlet and/or outlet airflow to reduce the amount of noise that is ultimately emitted from an enclosure having a noise emitting component therein, such as the cowling of an engine. For example, the various embodiments described herein, different air inlets and/or outlets may be configured to have a desired aspect ratio (e.g., length/width aspect ratio), eliminate line of sight from an engine (e.g., a noisy combustion engine) to any directions outside the aircraft that are noise sensitive, and/or line any internal noise-reflective surfaces with noise attenuating materials. Such embodiments as described herein advantageously provide for a weight-efficient and effective means of reducing operating noise from a noise emitting component, such as an aircraft hybrid powerplant.

The noise reducing embodiments described herein may be particularly advantageous for use in certain implementations. For example, some aircraft may have a hybrid powerplant that includes a combustion engine (e.g., turbine, rotary, piston) as well as an electric machine such as an electric motor/generator. Noise from such a hybrid generator will may be generated in and travel via the exhaust stream from the combustion engine, and further may escape via an airflow inlet for the combustion engine as well. While noise in an exhaust stream may be minimized with methods such as a muffler, other components of a hybrid powerplant and/or combustion engine may also generate noise, such as throughout the engine core, any cooling fans, pumps, and/or other accessory devices. Since that noise may generated at multiple places at once (e.g., from multiple sources/components), the noise may be hard to minimize.

Thus, the embodiments described herein are configured to reduce noise emitted by multiple sources (e.g., multiple powerplant or engine components that emit noise simultaneously). Noise may be carried from a noise source to a human car via a medium such as air. The embodiments herein include enclosing noise sources (e.g., an aircraft powerplant) and manage airflow into and out of such an enclosure (and subsequently to the aircraft powerplant). The embodiments described herein further provide for additional noise reduction through the addition of noise attenuating material to various portions of the enclosure and in various configurations to reduce noise that may escape the enclosure (including noise that may escape through air inlets or outlets of the enclosure). That noise attenuating material may be a noise attenuating foam or any other type of suitable material.

Such noise attenuating material may further be placed within the enclosure (e.g., within the air inlet and/or outlet) in specific orientations and/or geometries to limit noise while also not hindering overall system performance (e.g., not hindering airflow to or from the powerplant). Accordingly, described herein are also orientations and geometries that are advantageously sized so as to not introduce unwanted pressure loss to an inlet or exit cooling airflow stream (e.g., backpressure to an exit cooling airflow stream). In various embodiments, noise attenuating materials used may also be selected based on their noise attenuating properties, resistance to fluids, heat, and/or fire, resistance to humidity, resistance to mold, resistance to corrosion, etc., so that the noise attenuating material has properties that are desirable for a given application.

Advantageously, the embodiments described herein therefore enable noise emitting components to be operated with a lower noise signature, which may be desirable, for example, in hybrid electric power for aviation.

As just one example of a system where it may be advantageous to use the systems and methods described herein, a hybrid powerplant configured to generate electrical and mechanical power for an aircraft may emit or produce noise that is desirable to minimize. For example, such a hybrid powerplant may include a prime mover such as an engine using combustion to create shaft work/power. That combustion may create noise, and noise from combustion engines in other applications is often released to an environment directly or conditioned using a muffler or similar method.

However, in addition to the noise created by the prime mover (e.g., combustion engine), a hybrid powerplant may have one or more other sources of noise, which may include, but are not limited to: (i) fuel injectors opening and closing, (ii) pistons slapping the cylinder walls inside a piston engine, (iii) fans whipping the air and/or slot gaps on fans creating noise, (iv) fluid pumps (e.g., oil, water, fuel), and/or (v) mechanical vibrations traveling through various parts and pieces.

The collective noise of the above and any other components of a hybrid powerplant may be referred to herein as the ambient noise of running a hybrid powerplant. Such ambient noise emission and propagation to a surrounding environment may be greatly reduced using the various systems and methods described herein.

A hybrid powerplant may have another feature that permits noise emitted from the powerplant to be released into an environment. An air intake or inlet for cool air may be used for combustion in the engine and/or other cooling tasks of the powerplant. An air exhaust or outlet for warm or hot air may also be released into the atmosphere. Since airflow velocities at intakes and exhaust for an engine are typically low compared to the speed of sound (e.g., less than 0.3 Mach (Ma)), any noise generated by components of the hybrid powerplant may travel through either intake and/or exhaust airstreams of the engine. In other words, the air moving into and out of a hybrid powerplant may carry sound waves, and the systems and methods described herein advantageously describe geometries and materials for air intake and/or exhausts that provide for significant reduction of noise emitted from an enclosure (e.g., a cowling) for a noise emitting component (e.g., a hybrid powerplant, combustion engine, related components of the combustion engine, etc.).

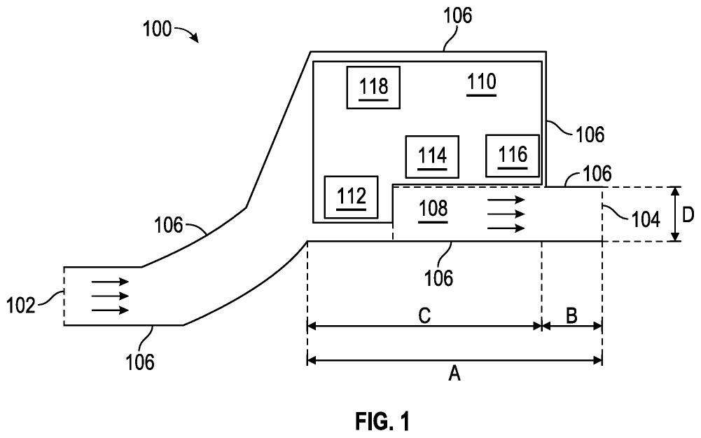

FIG. 1 illustrates a side cross-sectional view of an enclosure 100 having noise reduction components in accordance with an illustrative embodiment. The enclosure 100 includes an air inlet 102 (e.g., intake) and an air outlet 104 (e.g., exhaust) that may be fluidly connected so that air may flow from the air inlet 102 to the air outlet 104. Inside the enclosure 100 is a cavity 110 for components that may use that airflow, such as a combustion engine (e.g., piston, turbine, rotary). In various embodiments, the components in the cavity 110 may block a flow of air between the air inlet 102 and the air outlet 104 when the components are not operational. However, when the components are operational, those components may use and/or move air from the air inlet 102 to the air outlet 104. As such, even if components fill the cavity 110 and completely block and/or seal the inside of the enclosure between the air inlet 102 and the air outlet 104, the air inlet 102 and the air outlet 104 may still be considered to be fluidly connected while the components in the cavity are operation (e.g., while an engine is running). In various other embodiments, the components in the cavity 110 may not fully block a fluid path between the air inlet 102 and the air outlet 104. In such embodiments, air may still flow through the enclosure even when components in the cavity 110 are not operational.

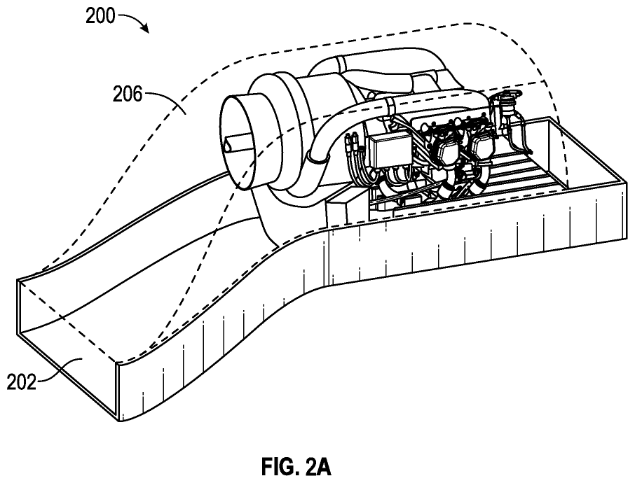

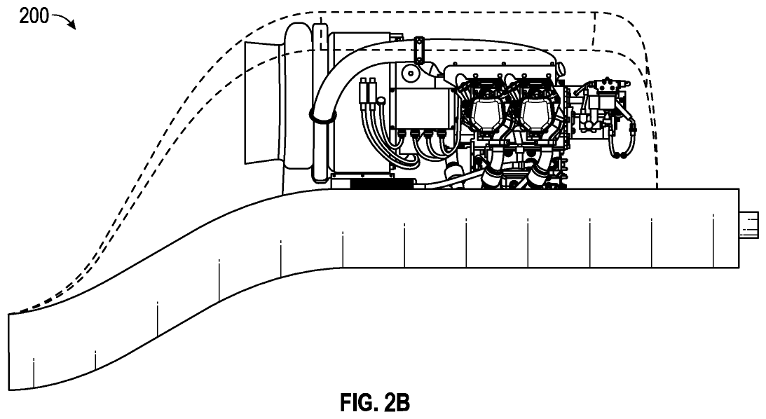

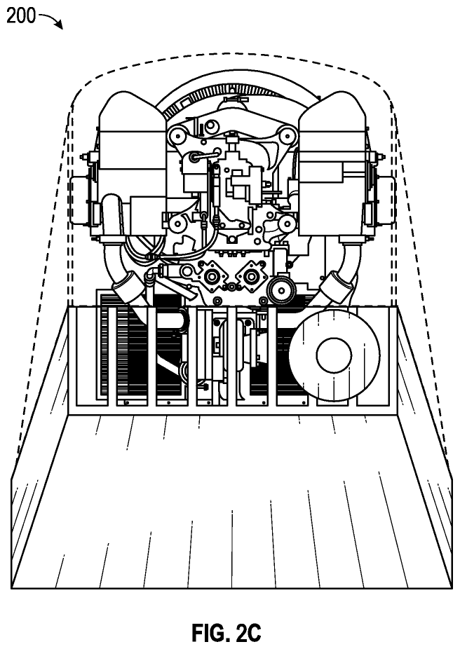

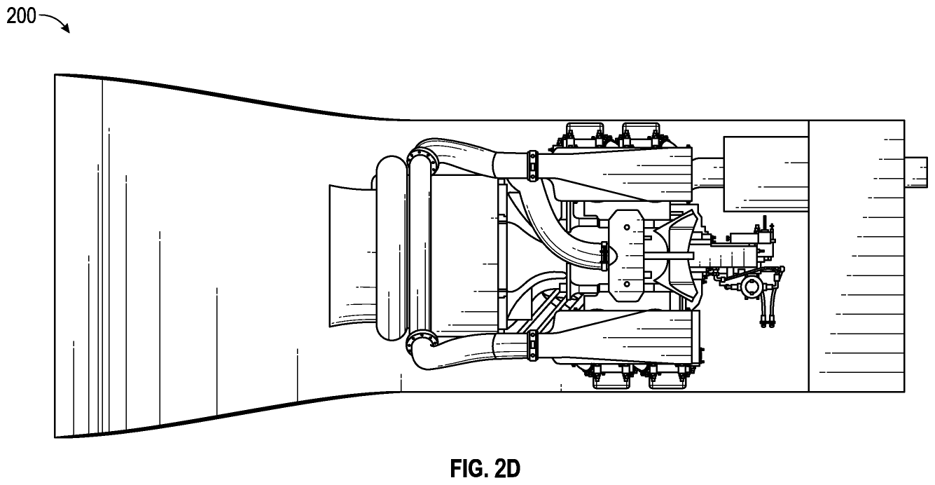

As further shown in FIG. 1, the enclosure 100 may be made up of various sidewalls 106. In various embodiments, the sidewalls 106 may be in varying configurations or shapes as desired based on the application, components to be fit inside the enclosure, where air inlets and outlets are desired, etc. The sidewalls 106 may also be configured to permit desired flow of air through the air inlet 102 and the air outlet 104, and subsequently supply enough air to an intake of the components in the cavity 110 as well as permitting sufficient exhaust from the components in the cavity 110. Examples of a differently shaped enclosures are shown in and further described below with respect to FIGS. 2-13. Any or all of the sidewalls 106 may be coated with, covered with, or be formed from or incorporating noise attenuating material to reduce noise within the enclosure 100, and therefore reduce noise that may escape the enclosure 100.

The sidewalls 106 of FIG. 1 are configured to have an opening to form the air inlet 102 and an opening to form the air outlet 104. In addition to forming the cavity 110, the sidewalls 106 also form a noise reduction chamber 108. While the noise reduction chamber 108 in FIG. 1 is shown between the cavity 110 and the air outlet 104, various embodiments may additionally or alternatively include a noise reduction chamber between the air inlet 102 and the cavity 110, or anywhere else that there is air flow within the enclosure 100.

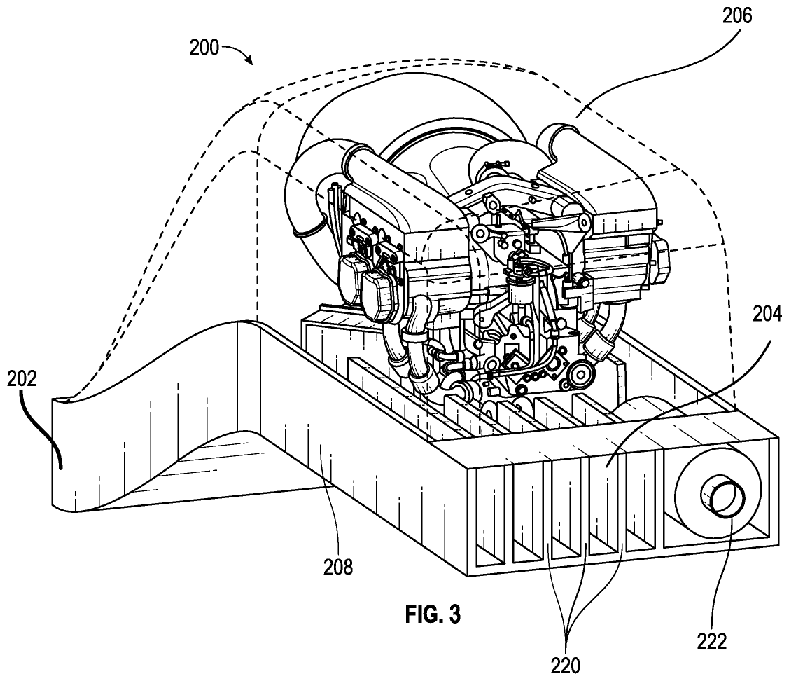

The noise reduction chamber 108 may include noise attenuating elements, such as channels formed by vertically oriented walls within the noise reduction chamber. Examples of such channels are shown in and described further with respect to FIGS. 3, 4, and 9-13. In various embodiments, channels that oriented in different ways may be used. For example, in addition to vertically oriented walls, walls may be oriented horizontally, at any angle, etc. In various embodiments, individual walls or multiple walls may be shaped to be vertically oriented, horizontally oriented, angled, or any combination thereof at different points in a wall. In such embodiments, the walls may be any shape as long as channels between the walls permit airflow to pass through.

Merely by way of example, various components 112, 114, 116, and 118, such as components of a hybrid powerplant for an aircraft, may be mounted or otherwise located at different positions within the cavity 110. More or less components may be typically included in the cavity 110, and various components may be in different locations with the cavity 110 than is shown in FIG. 1.

Because different components 112, 114, 116, and 118 may be in different locations within the cavity 110, those components 112, 114, 116, and 118 may produce or emit noise that is emitted from different locations within the cavity. Therefore, as discussed herein, it may be difficult to specifically tune noise reduction elements for each and every potential source of noise within the enclosure 100. Thus, the noise reduction chamber 108 may attenuate noise or vibration propagating in the exhaust air as it travels through the noise reducing chamber 108 to the air outlet 104 (or may attenuate noise or vibration propagating in inlet air as it travels from the air inlet to the components in the cavity 110, in embodiments where noise attenuating elements (e.g., a noise reduction chamber) is placed along an air inlet path). For example, the plurality of channels in the noise reducing chamber may be formed of noise attenuating material, such that noise or vibration is absorbed by the walls of those channels, thereby reducing the amount of noise or vibration that is present in any air output at the air outlet 104.

As shown in FIG. 1, different components 112, 114, 116, and 118 may be located further or closer to the air outlet 104 relative to one another based on their placement within the cavity 110. Accordingly, while the noise reducing chamber may have a total length of A as shown in FIG. 1, some of the components 112, 114, 116, and 118 may have noise and/or air exhaust that travels, at minimum, through the length B of the noise reduction chamber 108. Other of the components 112, 114, 116, and 118 may have noise and/or exhaust air that additionally travels through some or all of the length C of the noise reduction chamber 108 in addition to the length B of the noise reduction chamber 108. As such, it may be desirable in various embodiments to extend the noise reduction chamber beyond the cavity 110 (e.g., the length B) to ensure that noise emitted from any source within cavity travels at least a minimum distance B within the noise reduction chamber 108. As such, the noise reduction chamber 108 may have a first section associated with length C that is immediately adjacent to the cavity 110 and a second section associated with length B that is not immediately adjacent to the cavity 110. In other words, air from the cavity 110 would pass through the first section (e.g., length C) of the noise reduction chamber 108 prior to passing through the second section (e.g., length B) and then out through the air outlet 104.

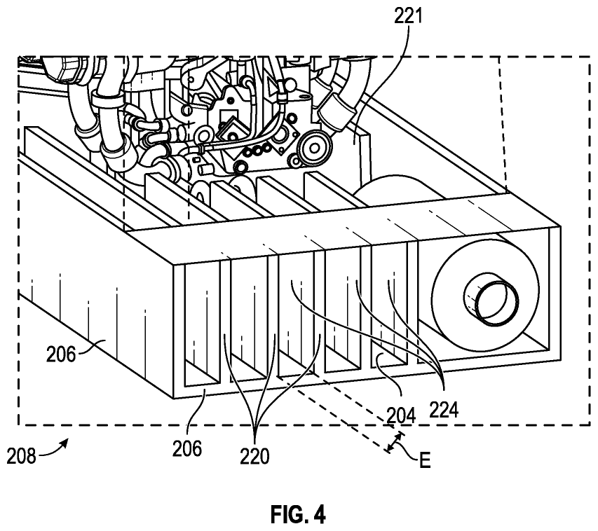

The noise reduction chamber 108 may also have a height D. A plurality of walls within the noise reduction chamber 108 may be configured to have a height approximately equal to D and a length approximately equal to A, such that the walls substantially fill the space of the noise reduction chamber 108 (e.g., as shown in FIG. 4). Since there is an opening between the cavity 110 and the noise reduction chamber 108, as well as an opening in the sidewalls 106 at the air outlet 104, air may therefore flow from the cavity 110, between the plurality of walls within the noise reduction chamber 108, and out through the air outlet 104. Since the plurality of walls within the noise reduction chamber 108 may be formed from a noise attenuating material, noise in air moving the noise reduction chamber 108 may be removed or reduced prior to the air's output at the air outlet 104. Although a noise reduction chamber associated with an outlet has been discussed and shown with respect to FIG. 1, it should be understood that a similar noise reduction chamber may be implemented in any space formed by the sidewalls between the cavity 110 and the air inlet 102, or even in any space within the cavity 110 itself.

FIG. 2A is a front perspective view showing an air inlet 202 of an example enclosure 200 having noise reduction components therein in accordance with an illustrative embodiment. The enclosure 200 is similar to that depicted in FIG. 1, and specifically shows the air inlet 202 side of the enclosure 200, as well as a sidewall 206 that, in part, forms a cavity within the enclosure 200 configured to hold components of a hybrid powerplant for an aircraft, such as a combustion engine and related components. FIG. 2B is a side view showing the example enclosure of FIG. 2A in accordance with an illustrative embodiment. FIG. 2C is a rear view showing the example enclosure of FIG. 2A in accordance with an illustrative embodiment. FIG. 2D is a top view showing the example enclosure of FIG. 2A in accordance with an illustrative embodiment.

FIG. 3 is a rear perspective view showing an air outlet 204 of the enclosure 200 of FIG. 2A in accordance with an illustrative embodiment. The enclosure 200 as shown in FIG. 3 shows the air outlet similar to the air outlet 104 of FIG. 1. Also visible in FIG. 3 is an edge of the air inlet 202 and another sidewall 206 that, in part, forms a cavity for a hybrid powerplant of an aircraft.

FIG. 3 also shows a plurality of walls 220 that may be formed within a noise reduction chamber 208 of the enclosure 200 (which is similar to the noise reduction chamber 108 of FIG. 1). A muffler 222 is also shown that may be within the noise reduction chamber 208 and between two of the plurality of walls 220, which may further reduce noise that is released to the atmosphere. The plurality of walls 220 may extend into the noise reduction chamber 208, where an opening at the top of the channels between the plurality of walls 220 between the noise reduction chamber 208 allows air flow between a cavity of the enclosure 200 and noise reduction chamber 208 (as further shown in FIG. 4).

FIG. 4 is a top perspective view of noise reducing channels 224 in the noise reducing chamber 208 of the enclosure 200 of FIG. 2A in accordance with an illustrative embodiment. In particular, the sidewalls 206 further form the noise reducing chamber 208, and the plurality of walls 220 form the plurality of channels 224. One wall 221 may be a different shape than the other plurality of walls 220 to, for example, accommodate the muffler 222 shown in FIG. 3. The plurality of walls 220 may be formed from a noise attenuating material such as foam, or any other suitable material. The plurality of channels 224 may have a width E. However, in various embodiments, the plurality of channels 224 may not all have the same width, and/or may have variable widths (e.g., may be wider closer to an enclosure cavity and get narrower near the air outlet 204, may be narrower closer to the enclosure cavity and get wider near the air outlet 204). In embodiments where the noise reduction chamber has an irregular shape or any other shape than that depicted in FIGS. 1-4, the plurality of walls may also be formed to have varying shapes to fit the noise reduction chamber and have desired proportions to create desired channel size (e.g., width E; lengths A, B, C; height D; etc.). The plurality of walls 220 may also have varying widths as desired, or may have a desired width that is optimized for noise reduction based on a particular application, material selected, etc. In addition, the plurality of channels may each have a cross-sectional area through which air flow. That cross-sectional area may be constant over a length of an individual channel, over the length of more than one (or all) channels, or may be variable. As discussed above, since the dimensions of the plurality of walls and the spacing between those walls may be varied, so too may the cross-sectional area of the channels formed by the walls be varied. For example, the cross-sectional area may be larger closer to the air outlet 204 than it is near a cavity of the enclosure 200, or the cross-sectional area may be smaller closer to the air outlet 204 than it is near a cavity of the enclosure 200.

As such, the plurality of walls within a noise reduction chamber, or other portion of an enclosure or cowling, may be arranged in any manner desired to achieve noise attenuation. The varying possible sizes of the plurality of walls and their associated channels may be referred to based on different aspect ratios applied to the geometry of the walls and channels. For example, a length/width ratio of a second section only (e.g., the part of the noise reducing chamber 208 that sticks out the back of the cavity) may be a length B of FIG. 1 over a width E of FIG. 4. As just one example, a desirable length width ratio of at least 1.3 may be desirable, for example a length B of twelve (12) inches and a width E of nine (9) inches for an aspect ratio of 1.333 may be used. Other aspect ratios may be used to configure the walls and channels of a noise reducing chamber, including any of the dimensions A, B, C, D, and/or E as demonstrated in FIGS. 1 and 4.

These aspect ratios may be advantageously configured to create channels with desirable aspect ratios from a perspective of permitting adequate airflow through a noise reducing chamber. For example, low pressure drop passage of air may be desired either at an enclosure input or output. On one hand, if the channels formed by parallel walls are too wide (e.g., if the spacing of the foam compared to the length and height of the channel is too broad) then noise reduction qualities may be reduced. On the other hand, if the channels are narrow and very long, there is ample opportunity for the pressure waves of the noise to be attenuated by coming into contact with the plurality of walls. Accordingly, for a given application, wall material type, etc., a balance of channel width (e.g., length E or distance between two parallel planes), height (e.g., length D), and length (e.g., length A or distance along the axis of airflow principal direction) is important to advantageously achieve to balance desirable noise reduction qualities of the channels without meaningfully affecting performance of the engine or other components within the enclosure.

One example noise attenuating material that may be used in the embodiments described herein includes a melamine open-cell foam made from melamine resin. This foam may be characterized by excellent noise absorption with high fire retardancy and resistance to flame and smoke. For example, open-cell or closed-cell foams may be used, and may be formed from varying materials such as melamine, cellulose, polyethylene, cotton, any other suitable material, or any combination thereof. The plurality of walls described herein may have any desired thickness, and merely by way of example, thicknesses of one (1) inch to two (2) inches may be used. If different materials are used as the noise attenuating material, the thickness may be varied based on the properties of that material or combination of materials. The noise attenuating material and/or walls described herein may also be lined/coated with another material or may not be lined/coated with any other material. The walls configured to attenuate noise described herein may also be patterned in different ways to reduce resistance for airflow (e.g., smoother patterns) and/or increase noise attenuation. For example, the materials described herein may be formed to have a smooth surface, egg-crate surface pattern, pyramid-shaped surface pattern, wedge-shaped surface pattern, hemisphere-shaped surface pattern, wave-shaped surface pattern, any other pattern, or any combination thereof.

In the embodiment shown in FIG. 4, the foam walls are thick enough such that the walls can be freestanding without having an internal support system within the foam of another type of material. Optionally, other materials could be used within the foam to support it, such as a thin center plate (e.g., carbon fiber) that is then coated on either side by a noise attenuating material such as foam.

The walls are further arranged to create channels as described herein, such that air may pass between parallel or substantially parallel planes of foam. In this way, sound pressure waves may be attenuated while the core flow of air through a noise reduction chamber has minimal restriction as it heads into or out of the system. As such, it is desirable to configure the walls and the channels between them such that there is not too much aerodynamic resistance (e.g., pressure loss) airflow streams (e.g., for air flow used for cooling engine components), then performance of an engine (including e.g., performance of cooling systems) may degrade. With properly sized channels such an effect of decreased performance may be minimized. In various embodiments, as described herein, non-parallel walls may additionally or alternatively be used.

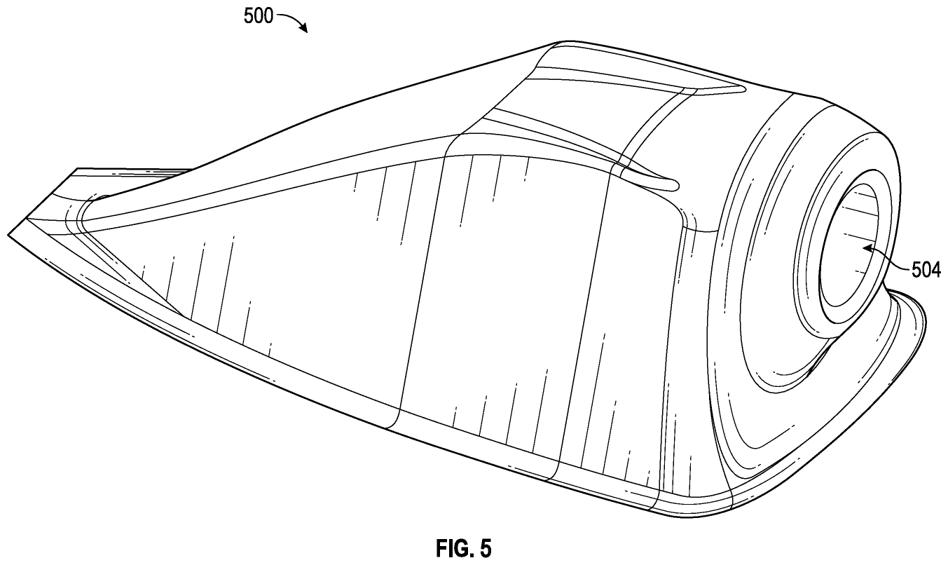

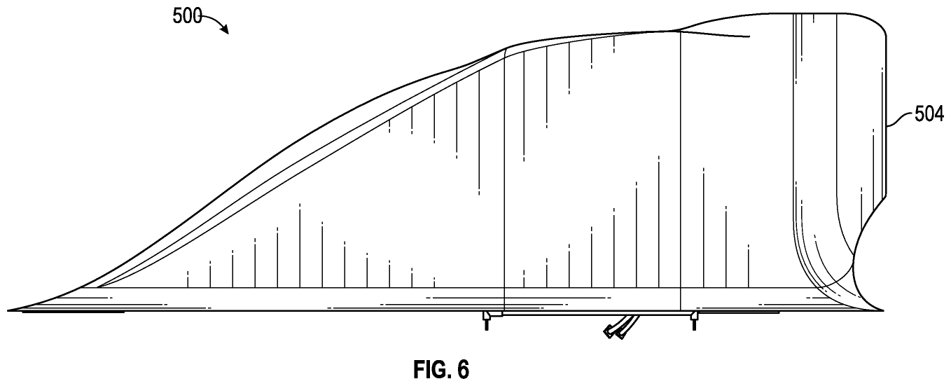

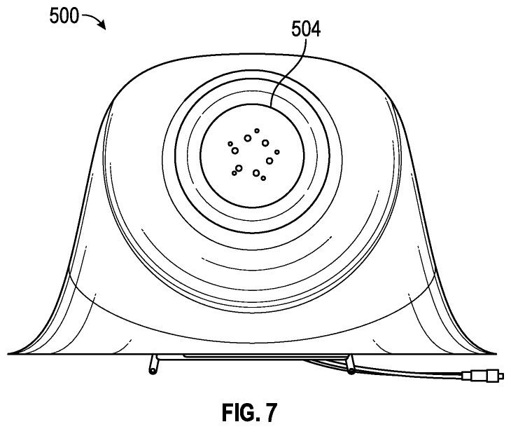

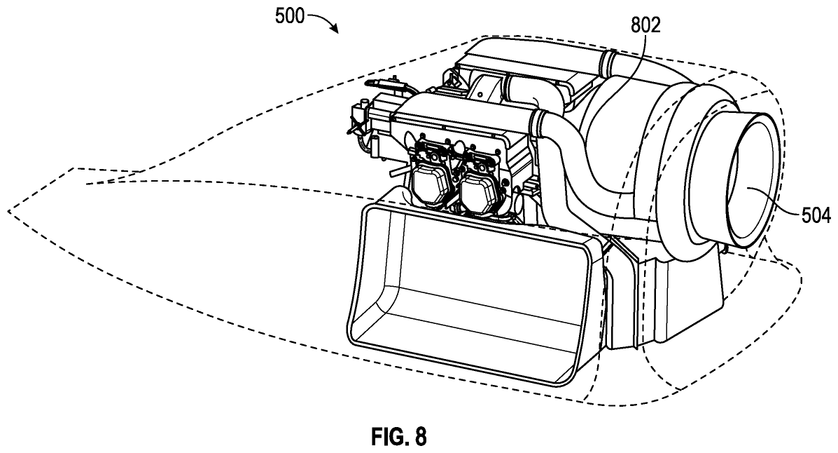

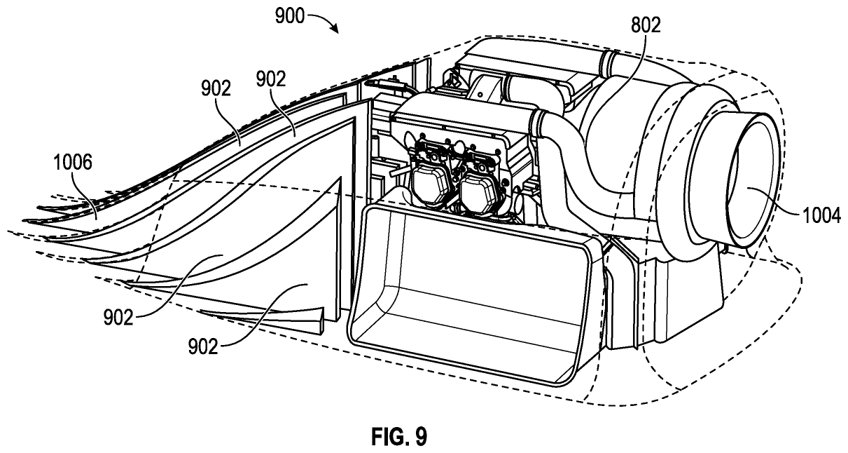

FIG. 5 is a top perspective view of another example enclosure 500 having noise reduction components therein in accordance with an illustrative embodiment. FIG. 6 is a side view of the enclosure 500 of FIG. 5 in accordance with an illustrative embodiment. FIG. 7 is a front view of the enclosure 500 of FIG. 5 in accordance with an illustrative embodiment. FIG. 8 is a perspective view of the enclosure 500 of FIG. 5, showing the enclosure as being partially transparent in accordance with an illustrative embodiment. The enclosure 500 of FIGS. 5-8 includes an air inlet 504 and an air outlet (not shown in FIGS. 5-8, but a similar enclosure with an outlet 1006 is shown in FIGS. 9-13). The enclosure 500 may specifically be a cowling of an engine or hybrid powerplant for an aircraft. The enclosure 500 may also be designed to be an external surface of an aircraft, such that the enclosure 500 is aerodynamic and the air inlet 504 is oriented toward a front of the aircraft. As shown in FIG. 8 where the enclosure 500 is partially transparent, engine components 802 may be in a cavity of the enclosure 500. As shown and described further below with respect to FIGS. 9-13, an enclosure similar to the enclosure 500 may have a plurality of noise attenuating walls therein in order to implement the noise reducing advantages described herein.

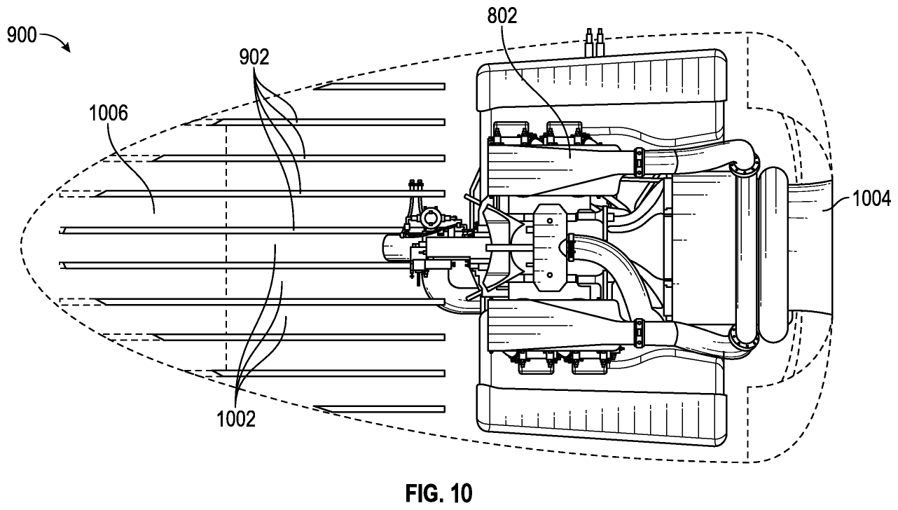

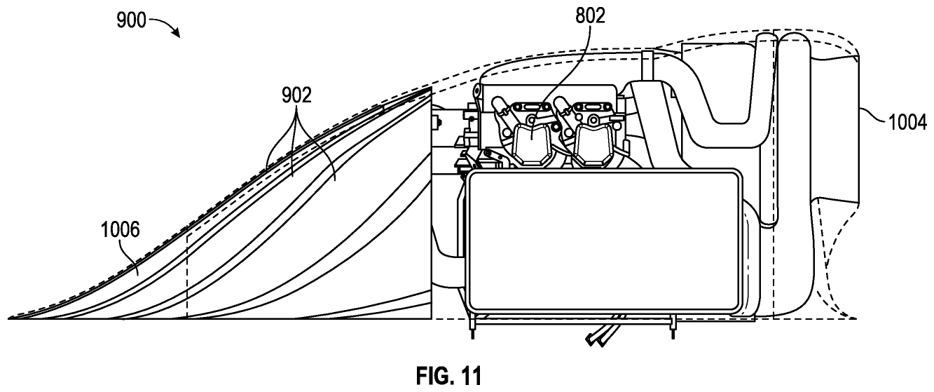

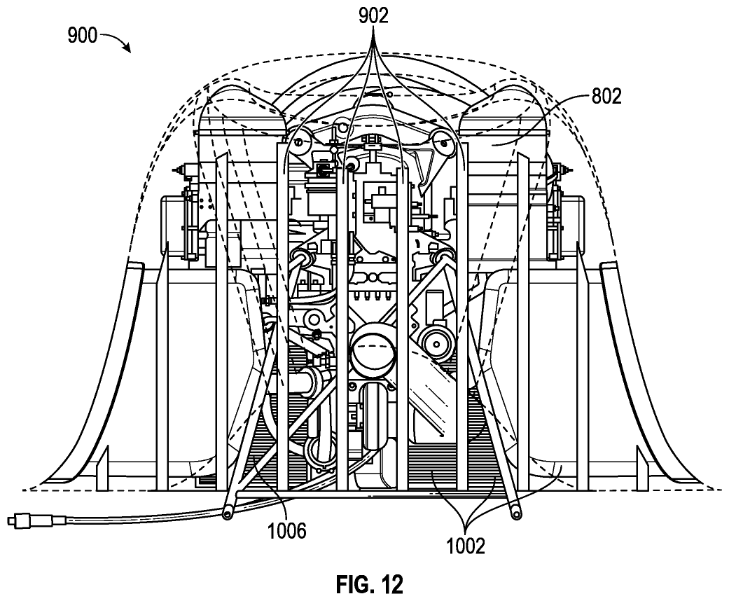

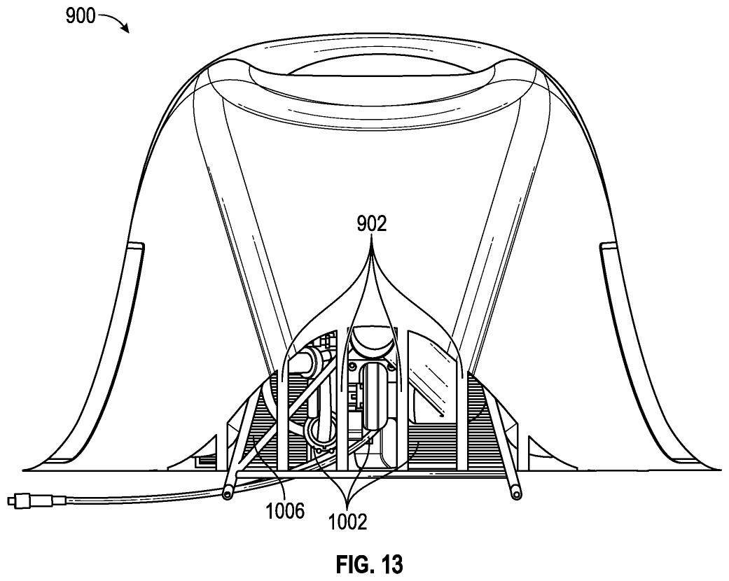

FIG. 9 is a perspective view of another example enclosure 900, showing the enclosure as being partially transparent and having noise reduction components therein in accordance with an illustrative embodiment. FIG. 10 is a top view of the enclosure 900 of FIG. 9 in accordance with an illustrative embodiment. FIG. 11 is a side view of the enclosure 900 of FIG. 9 in accordance with an illustrative embodiment. FIG. 12 is a rear view of the enclosure 900 of FIG. 9 in accordance with an illustrative embodiment. FIG. 13 is a rear view of the enclosure 900 of FIG. 9, except showing the enclosure as opaque in accordance with an illustrative embodiment.

In particular, FIGS. 9-13 show a plurality of walls within the enclosure 900 that form a plurality of channels 1002 for reducing noise emitted by and/or produced by engine components 802. The enclosure 900 further includes an air inlet 1004 and an air outlet 1006 so that air may be used by the engine components 802 and output out of the outlet 1006 after use. The enclosure 900 may be attached to an aircraft to supply electrical power to such an aircraft. While FIGS. 9-12 show the enclosure as partially transparent such that the components inside the enclosure 900 are apparent, FIG. 13 shows the enclosure as opaque so as to better demonstrate the air outlet 1006. As shown in FIGS. 9-13, the plurality of walls may be varying in shape as a result of the shape of the enclosure itself. Thus, as shown in this example, a plurality of walls may be customized to fit any space within a cowling or enclosure to reduce noise emitted by the components therein.

The foregoing description of illustrative embodiments has been presented for purposes of illustration and of description. It is not intended to be exhaustive or limiting with respect to the precise form disclosed, and modifications and variations are possible in light of the above teachings or from practice of the disclosed embodiments. It is intended that the scope of the invention be defined by the claims appended hereto and their equivalents.

What is claimed is:

1. An enclosure for reducing noise emitted from an aircraft powerplant comprising:
an air inlet;
an air outlet; and
at least one sidewall forming the enclosure and fluidly connecting the air inlet and the air outlet, wherein the at least one sidewall forms a noise reduction chamber comprising a plurality of channels configured to permit air to pass through the noise reduction chamber.

2. The enclosure of claim 1, further comprising a cavity configured to house at least one component of the aircraft powerplant, wherein the cavity is within the enclosure and formed by the at least one sidewall.

3. The enclosure of claim 2, wherein the noise reduction chamber is located in a fluid path between the cavity and the air outlet.

4. The enclosure of claim 3, wherein exhaust air from the at least one component of the aircraft powerplant is configured to pass through the noise reduction chamber before exiting the enclosure via the air outlet.

5. The enclosure of claim 4, wherein the exhaust air passes through the plurality of channels.

6. The enclosure of claim 4, wherein walls of the plurality of channels are configured to absorb noise or vibration present in the exhaust air.

7. The enclosure of claim 6, wherein the walls are formed from a noise attenuating material.

8. The enclosure of claim 7, wherein the noise attenuating material comprises a noise attenuating foam.

9. The enclosure of claim 2, wherein the noise reduction chamber is located in a fluid path between the cavity and the air inlet.

10. The enclosure of claim 1, wherein the plurality of channels in the noise reduction are formed by a plurality of walls within the noise reduction chamber.

11. The enclosure of claim 10, wherein the plurality of walls are substantially parallel to one another.

12. The enclosure of claim 10, wherein the plurality of walls are each substantially straight walls.

13. The enclosure of claim 10, wherein the plurality of walls are each curved.

14. The enclosure of claim 10, wherein the plurality of channels each has a constant cross-sectional area through which air is configured to pass through the noise reduction chamber.

15. The enclosure of claim 10, wherein the plurality of channels each has a variable cross-sectional area through which air is configured to pass through the noise reduction chamber.

16. The enclosure of claim 10, wherein each of the plurality of walls is approximately one (1) inch to two (2) inches thick.

17. The enclosure of claim 2, wherein the noise reduction chamber comprises a first section adjacent to the cavity and a second section connected to the first section, wherein the second section is not immediately adjacent to the cavity.

18. The enclosure of claim 17, wherein the second section is located along a fluid path between the first section and the air outlet.

19. The enclosure of claim 18, wherein each of the plurality of channels extends from the first section to the second section of the noise reduction chamber, such that each of the plurality of channels comprises a first channel section in the first section of the noise reduction chamber and a second channel section in the second section of the noise reduction chamber.

20. The enclosure of claim 19, wherein a length of the second channel section of each of the plurality of channels is at least twelve (12) inches in length.

21. The enclosure of claim 19, wherein a length/width aspect ratio of the second channel section of each of the plurality of channels is at least 1.3.

22. The enclosure of claim 1, wherein a width of each of the plurality of channels is approximately nine (9) inches.

23. An enclosure comprising:
an air inlet;
an air outlet;
at least one sidewall forming the enclosure and fluidly connecting the air inlet and the air outlet, wherein the at least one sidewall forms a chamber; and
a plurality of inner walls in the chamber that form a plurality of channels configured to permit air to pass through the chamber, wherein the plurality of inner walls are parallel to one another.

24. An apparatus comprising:
an engine;
an enclosure, wherein the engine is inside the enclosure, and the enclosure further comprises:
an air inlet;
an air outlet;
at least one sidewall forming the enclosure and fluidly connecting the air inlet and the air outlet, wherein the at least one sidewall forms a chamber; and
a plurality of inner walls in the chamber that form a plurality of channels configured to permit air to pass through the chamber, wherein exhaust air from the engine passes through the plurality of channels.
